(19) United States
(12) Patent Application Publication
(10) Pub. No.: US 2008/0164787 A1
(43) Pub. Date: Jul. 10, 2008

(54) JOINT DEVICE FOR ASSEMBLED FURNITURE AND FOLDABLE CABINET USING THE JOINT DEVICE

(76) Inventor: Ju Mei Peng, Dongguan (CN)

Correspondence Address: BYIP, LTD., P.O. BOX 1484, GENERAL POST OFFICE, HONG KONG, omitted

(21) Appl. No.: 11/965,740

(22) Filed: Dec. 28, 2007

(30) Foreign Application Priority Data
Jan. 9, 2007 (CN) 200720117944.2

(51) Int. Cl. A47B 87/00; F16C 11/00

(52) U.S. Cl. 312/108; 411/347; 403/119

(57) ABSTRACT

The present application is directed to a joint device for assembled furniture and a foldable cabinet using the joint device. The joint device for assembled furniture includes a sheath and a bolt. The sheath includes an outer flank adapted to be tightly fitted in a hole of a first furniture member. The bolt includes a first end adapted to be inserted into a cavity of the sheath and a second end adapted to be tightly fitted in a hole of a second furniture member. The sheath includes an elastic material. The first end of the bolt is snugly engaged with the cavity of the sheath when inserted into the cavity of the sheath.

### CROSS REFERENCE

The present patent application claims the priority of Chinese Patent Application No. 200720117944.2, filed Jan. 9. 2007.

### FIELD OF THE APPLICATION

The present application relates to a foldable cabinet and a joint device for furniture. Particularly, the present application is directed to a joint device for assembled furniture and a foldable cabinet using the joint device.

### BACKGROUND

Cabinet is a large category of furniture. Since the demand of assembled furniture has increased, foldable cabinets are getting more and more popular in the market. The foldable cabinets can be folded to save spaces. Since the conventional foldable cabinets use screws to join frames and panels, the assemblers have to use the tools, such as screwdrivers, etc., to assemble the frames and panels together.

To solve this problem, Chinese Patent Application No. 03280122.X, filed on Sep. 25 2003, disclosed an assembled cabinet. The assembled cabinet has a tube-jointed securing member for jointing pre-assembled frames and panels. The tube-jointed securing member includes a tube and a fitting bolt attached to the tube. The bolt includes a head and a screw body. The size of the head is larger than the inner diameter of the tube, and the head can be tightly inserted into the tube. The screw body can be tightly fitted in the frame and the panel.

The assembled cabinet described above overcomes the disadvantage of using a screwdriver during the assembly. Although the cabinet can be assembled by hand without using any tools, it still has the following disadvantages:

1. When the screw body of the bolt is in the frame or the panel, the screw cannot be tighten by hand since the screw body should be tightly fitted inside the frame or the panel. The assembler eventually has to use a screwdriver to assemble the cabinet.

2. When disassembling the panels or the frames, the tubes of the tube-jointed securing members have to be pulled out from the holes in the panels or the frames. After a few times of assembly and disassembly, the tubes will become loosen in the holes. Therefore, the cabinet will become unstable after several times of assembly and disassembly.

### SUMMARY

The present application is directed to a joint device for assembled furniture. The joint device for assembled furniture includes a sheath and a bolt. The sheath includes an outer flank adapted to be tightly fitted in a hole of a first furniture member. The bolt includes a first end adapted to be inserted into a cavity of the sheath and a second end adapted to be tightly fitted in a hole of a second furniture member. The sheath includes an elastic material The first end of the bolt is snugly engaged with the wall of the cavity of the sheath when inserted into the cavity of the sheath.

The present application is also directed to a foldable cabinet using the joint device. The cabinet includes a supporting plate, top and bottom plates. The top and bottom plates are jointed to the supporting plates. A joint device is provided to join the supporting plate to at least one of the top and bottom plates. The joint device includes a sheath and a bolt. The sheath includes an outer flank adapted to be tightly fitted in a hole of a first furniture member. The bolt includes a first end adapted to be inserted into a cavity of the sheath and a second end adapted to be tightly fitted in a hole of a second furniture member. The sheath includes an elastic material. The first end of the bolt is snugly engaged with the wall of the cavity of the sheath when inserted into the cavity of the sheath.

### BRIEF DESCRIPTION OF THE DRAWINGS

FIG. 1 is an exploded view of a joint device for assembled furniture in accordance with an embodiment of the present application.

FIG. 2 is a sectional view of the joint device for the assembled furniture.

FIG. 3 is an exploded view of the joint device assembled in furniture pieces.

FIG. 4 is an exploded view of a foldable cabinet using the joint device in accordance with an embodiment of the present application.

FIG. 5 is a perspective view of the foldable cabinet when it is folded.

FIG. 6 is a perspective view of the foldable cabinet when it is in use.

FIG. 7 is a perspective of a hinge of the foldable cabinet.

FIG. 8 shows a floor space occupied by the foldable cabinet, when it is in use.

### DETAILED DESCRIPTION

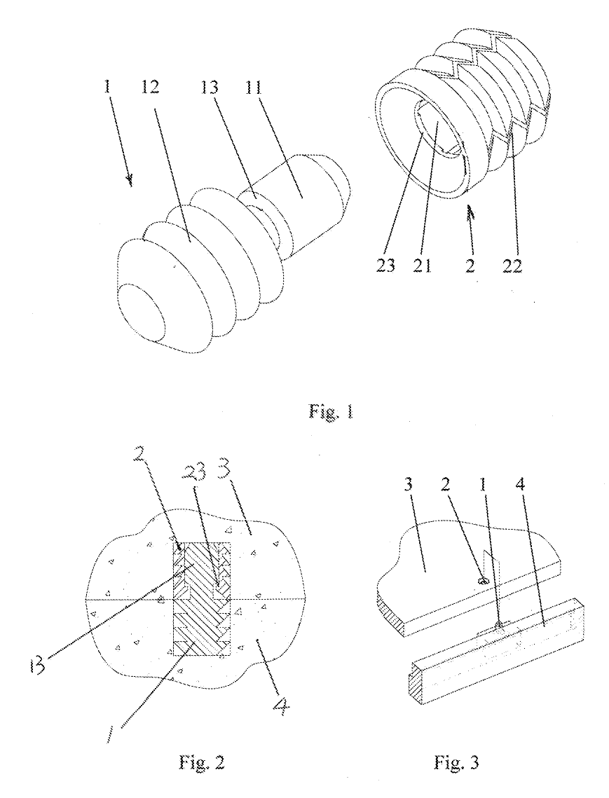

FIGS. 1-3 show a joint device for assembled furniture in accordance with an embodiment of the present application. The joint device includes a bolt 1 and a sheath 2 for receiving the bolt 1. The bolt I has a first end 11 adapted to be inserted into the cavity 21 of the sheath 2. The bolt 1 also has a second end 12 adapted to be tightly fitted in a hole of a furniture member 4. The sheath 2 has an outer flank 22 adapted to be tightly fitted in a hole of a furniture member 3. The first end 11 of the bolt 1 is snugly engaged with the wall of the cavity 21 of the sheath 2 when the first end 11 is inserted into the cavity of the sheath 21.

The sheath 2 can be made of elastic materials, such as plastic. The outer flank 22 of the sheath 2 includes a sawtooth shaped fringe extending along its axial direction. Because of the elastic feature of the sawtooth shaped fringe, the sheath 2 can be easily inserted into the hole of the furniture member 3 by hand and also can be tightly fitted in the hole. In addition, the engagement and disengagement of the bolt 1 and the sheath 2 do not cause the looseness of the sheath 2 in the hole of the furniture member 3.

In other embodiments, to ensure the outer flank 22 of the sheath 2 to be tightly fitted in a hole of the furniture, the outer flank 22 of the sheath 2 can be built with other structures having elastic characteristics. The sheath 2 can also be made of elastic rubber or other kinds of elastic materials. Since the outer flank 22 of the sheath 2 can be tightly fitted in the hole of the furniture member, the joint portion of the furniture is stable.

The bolt 1 can be made of metal materials, so that the second end 12 of the bolt 1 can be tightly fitted in a hole of the furniture member 4. In the illustrated embodiment, the bolt 1 is made of an elastic material, such as plastic. An outer flank of the second end 12 includes a sawtooth shaped fringe extending along its axial direction. Because of the elastic feature of the sawtooth shaped fringe, the second end 12 of the bolt 1 can be easily inserted in the hole of the furniture member 4 by hand and also can be tightly fitted in the hole.

In addition, in order to conveniently engage the bolt 1 with the sheath 2 and insert the bolt 1 into the hole of the furniture member, chamfers can be provided at the tip of the first end 11 and at the tip of the second end 12 of the bolt 1. A chamfer can also be provided at the bolt-entry end of the sheath 2.

Referring particularly to FIG. 2, a protrusion 13 can be provided at the first end 11 of the bolt 1. The protrusion 13 ensures the first end 11 of the bolt 1 to be snugly engaged with the wall of the cavity 21 of sheath 2, so that the first end 11 of the bolt 1 can be prevented from disengaging from the cavity 21. A groove 23 can be provided at the cavity 21 of the sheath 2, corresponding to the protrusion 13 of the bolt 1 when the sheath 2 and the bolt 1 are engaged. The protrusion 13 can be continuous ring-shaped as shown in the illustrated embodiment or can have a plurality of discontinued projections. In one embodiment, the protrusion 13 can be made of an elastic material, which increases the stability of the engagement of the bolt 1 and the sheath 2.

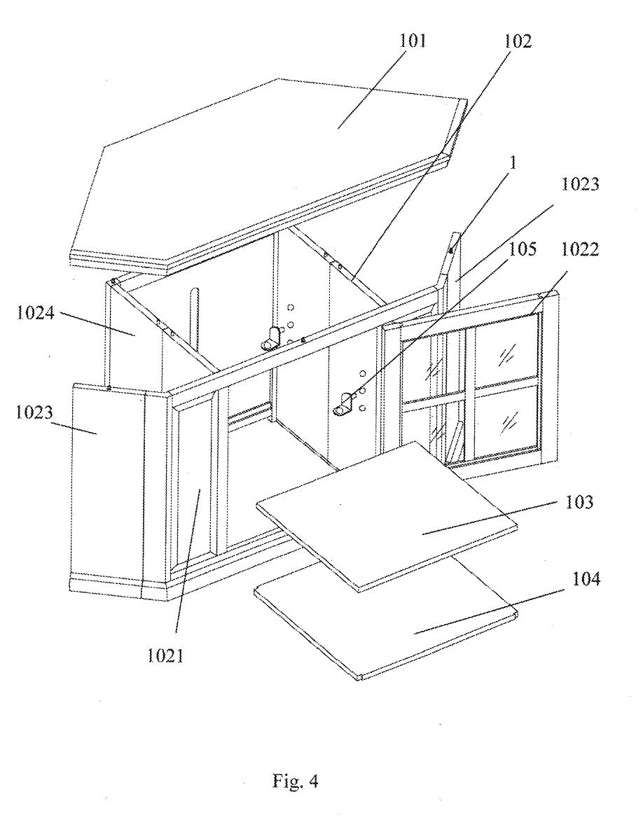

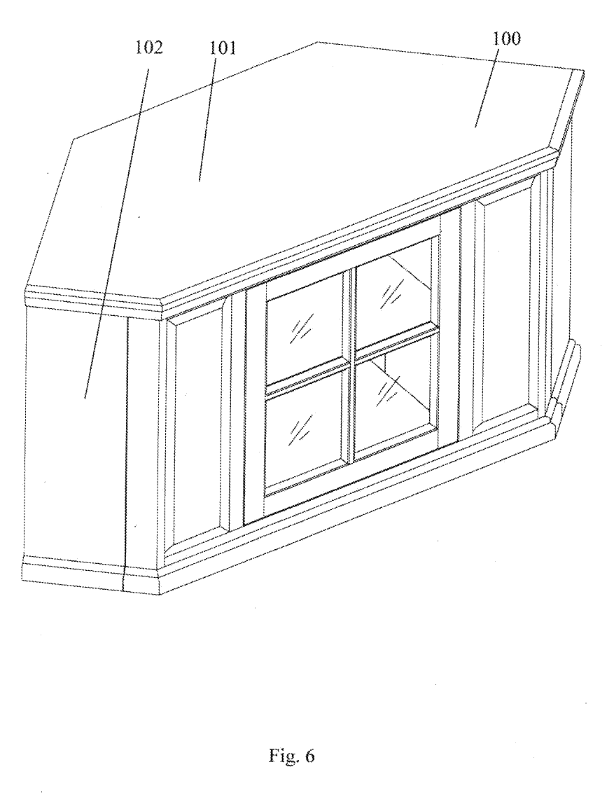

FIGS. 4-6 show a foldable cabinet 100 using the joint devices described above. The foldable cabinet 100 includes supporting plates 102, a top plate 101 a bottom plate 104 and a layer plate 103. The supporting plate 102 includes a plurality of foldable members connected with each other by hinges. The upper side of the supporting plates 102 and the bottom side of the top plate 101 have holes for receiving the joint devices described above, so that the supporting plates 102 and the top plate 101 can be assembled together.

The bottom plate 104 can be placed on flanges of the supporting plates 102. A plurality of supporting members 105 are mounted to the inner wall of the foldable members of the supporting plates 102 for supporting the layer plate 103.

In one embodiment, the layer plate 103 and supporting members 105 can be omitted.

In one embodiment, the bottom plate 104 and the supporting plates 102 can be assembled together by using the joint devices described above. The top plate 101 can be placed on flanges at the upper side of the supporting plates 102.

In one embodiment, the supporting plates 102 can be assembled to both the top plate 101 and the bottom plate 104 using the joint devices described above.

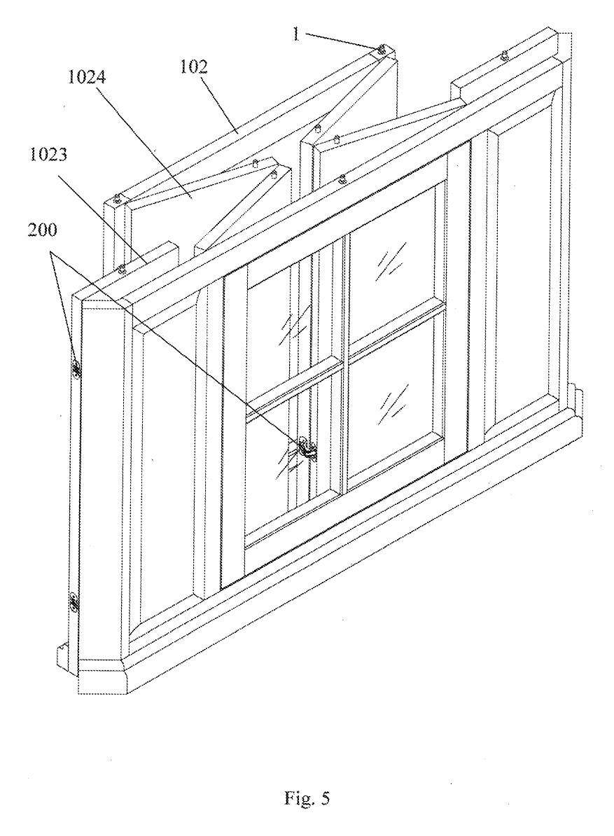

In the illustrated embodiment as shown in FIGS. 4 and 5, the foldable cabinet 100 includes a front portion and a back portion. The front portion includes a middle frame 1021, a front door 1022 hinged to the middle frame 1021, and two side plates 1023 hinged to two sides of the middle frame 1021 respectively. The hack portion includes foldable members 1024 jointed together by hinges. Two of the foldable members 1024 are hinged to the middle frame 1021 at the left side and the right side of the middle frame 1021, respectively. The side plates 1023 are hinged to the middle frame 1021 at its left side and right side.

To ensure the foldable cabinet 100 to stably stand, the bottom sides of the supporting plates 102 are on the same plane. The bottom surfaces of the front portion and the back portion of the foldable cabinet 100 can be on the same plane.

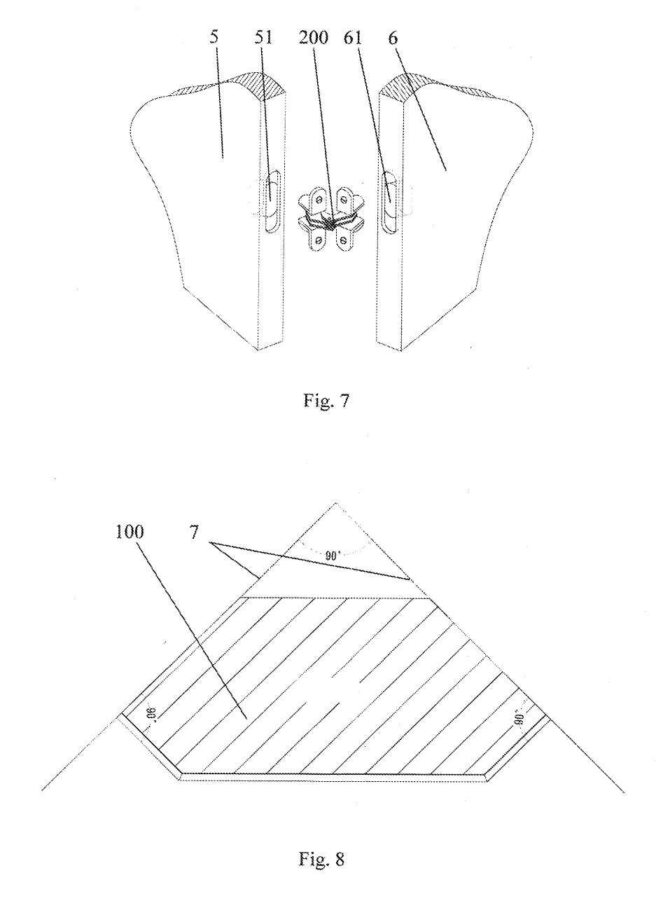

The hinges as used in the foldable cabinet 100 can be conventional hinges. The hinge, as shown in FIG. 7, can pivot 180 degree. It can be mounted in the holes 51 and 61 of the furniture members 5 and 6.

FIG. 8 shows a floor space occupied by the foldable cabinet when it is in use. The foldable cabinet 100 can be manufactured as a corner cabinet in accordance with the shape of the inner corner of a wall for placing a TV set and audio devices.

In one embodiment, the foldable cabinet 100 can be a cubic cabinet.

While preferred embodiments of the foregoing application have been set forth for the purpose of illustration, the foregoing description should not be deemed a limitation of the application herein. Accordingly; various modifications, adaptations and alternatives may occur to one of skill in the art without, departing from the spirit and scope of the present application.

I claim:

1. A joint device for assembled furniture, comprising:
a sheath comprising an elastic material and an outer flank adapted to be tightly fitted in a hole of a first furniture member; and
a bolt comprising a first end adapted to be inserted into a cavity of the sheath and a second end adapted to be tightly fitted in a hole of a second furniture member, and the first end of the bolt snugly engaged with a wall of the cavity of the sheath when inserted into the cavity of the sheath.

2. The joint device according to claim 1, wherein the elastic material of the sheath comprises plastic or rubber.

3. The joint device according to claim 1, wherein the outer flank of the sheath comprises a sawtooth shaped fringe along an axial direction of the sheath.

4. The joint device according to claim 1, wherein the first end of the bolt comprises a protrusion, and a groove is provided at the cavity of the sheath, corresponding to the protrusion of the bolt when the sheath and the bolt are engaged.

5. The joint device according to claim 4, wherein the protrusion comprises a continuous ring shape.

6. The joint device according to claim 4, wherein the protrusion comprises a plurality of discontinued projections.

7. The joint device according to claim 4, wherein the protrusion comprises an elastic material.

8. The joint device according to claim 1, wherein the bolt comprises an elastic material.

9. The joint device according to claim 1, wherein the bolt comprises a metal material.

10. The joint device according to claim 1, wherein the second end of the bolt comprises an outer flank, and the outer flank comprises a sawtooth shaped fringe along an axial direction of the bolt.

11. A cabinet comprising a supporting plate, top and bottom plates which are jointed to the supporting plates, a joint device joining the supporting plate to at least one of the top and bottom plates, the joint device comprising:
a sheath comprising an elastic material and an outer flank adapted to be tightly fitted in a hole of a first furniture member; and
a bolt comprising a first end adapted to be inserted into a cavity of the sheath and a second end adapted to be tightly fitted in a hole of a second furniture member, and the first end of the bolt snugly engaged with a wall of the cavity of the sheath when inserted into the cavity of the sheath.

12. The cabinet according to claim 11, wherein the outer flank of the sheath comprises a sawtooth shaped fringe along an axial direction of the sheath.

13. The cabinet according to claim 11, wherein the first end of the bolt comprises a protrusion, and a groove is provided at the cavity of the sheath, corresponding to the protrusion of the bolt, when the sheath and the bolt are engaged.

14. The cabinet according to claim 11, wherein the second end of the bolt comprises an outer flank, and the outer flank comprises a sawtooth shaped fringe along an axial direction of the bolt.

15. The cabinet according to claim 11, wherein the supporting plate comprises a plurality of foldable members connected with each other by hinges.

16. The cabinet according to claim 11 comprising:
a front portion comprising a middle frame, a front door hinged to the middle frame, and
two side plates hinged to two sides of the middle frame respectively; and
a back portion comprising a plurality of foldable members connected with each other by hinges.

17. The cabinet according to claim 16, wherein two of the foldable members are hinged to the middle frame at a left side and a right side of the middle frame, respectively.

18. The cabinet according to claim 16, wherein the two side plates are hinged to the middle frame at a left side and a right side of the middle frame, respectively.

19. A joint device for assembled furniture, comprising:
a sheath comprising an elastic material and an outer flank adapted to be tightly fitted in a hole of a first furniture member, the outer flank comprising a sawtooth shaped fringe along an axial direction of the sheath; and
a bolt comprising a first end adapted to be inserted into a cavity of the sheath and a second end adapted to be tightly fitted in a hole of a second furniture member, the first end of the bolt snugly engaged with the wall of the cavity of the sheath when Inserted into the cavity of the sheath, and the second end of the bolt comprising an outer flank including a sawtooth shaped fringe along an axial direction of the bolt.

20. The joint device according to claim 19, wherein the first end of the bolt comprises a protrusion, and a groove is provided at the cavity of the sheath, corresponding to the protrusion of the bolt when the sheath and the bolt are engaged.
